(19) United States
(12) Patent Application Publication
(10) Pub. No.: US 2020/0293574 A1
(43) Pub. Date: Sep. 17, 2020

(54) Audio Search User Interface

(71) Applicant: Universite de Mons, Mons (BE)

(72) Inventors: Gabriel Urbain, Gent (BE); Alexis Moinet, Cambridge (GB); Christian Frisson, Montreal ,QC (CA)

(73) Assignee: Universite de Mons, Mons (BE)

(21) Appl. No.: 16/086,069

(22) PCT Filed: Mar. 17, 2017
(86) PCT No.: PCT/EP2017/056395

§ 371 Date: Sep. 18, 2018

(30) Foreign Application Priority Data
Mar. 18, 2016 (EP) 16161207.2

(51) Int. Cl. G06F 16/683; G10L 15/18; G06F 16/65

(52) U.S. Cl. CPC G06F 16/683; G06F 16/65; G10L 15/1815

(57) ABSTRACT

The present invention is related to a method for indexing audio files comprising the steps of: i) for each audio file, collecting semantic descriptor of the audio file; ii) for each audio-file, generate perceptual information based upon audio content of the file; iii) based upon said perceptual information, generate perceptual descriptor in the form of string data for each audio-file; iv) for each file, create an index comprising both the semantic data and the perceptual descriptor.

### FIELD OF THE INVENTION

The present invention is related to a method for indexing and searching audio content in an audio database.

### STATE OF THE ART

Sound designers source sounds in massive collections. They usually rely either on text-based queries to narrow down a sub-set from these collections when looking for specific content or on content-based similarity. However, when it comes to unknown collections, this approach can fail to precisely retrieve files according to their content.

In order to search and classify big sound archives, two strategies have been studied during the past decades. The first one consists in crawling the web to retrieve semantic data describing the sound. However, most of the timbral concepts cannot be captured with semantic data without a subjective interpretation. The second strategy focuses on extracting descriptors from audio files to depict and understand them according to their content. Recently, combination of both methods have been conducted to provide results matching at best the human perception. For instance, in article “Query-by-example retrieval of sound events using an integrated similarity measure of content and label”, in Image Analysis for Multimedia Interactive Services (WIAMIS), 2013 14th

International Workshop pages 1-4. IEEE, 2013. A. Mesaros, T. Heittola, and K. Palomaki, this approach has been successfully evaluated for different kinds of sounds. Likewise, Freesound has created a web architecture for content-based information retrieval interfacing with Apache Solr and a Search User Interface (SUI) presenting the results in a traditional scrollable vertical list. Other research in Image Information Retrieval like Loki+Lire also studied the use of Apache Solr to increase the performance of their systems and a custom SUI to show the results in an image grid.

Perceptual audio similarity is a very subjective concept and remains difficult to define despite very active researches in the area. The Query by Example (QBE) paradigm tries to overcome this issue by finding similar sounds to a given audio example. A first approach to QBE was introduced in “Content-based classification, search, and retrieval of audio.” MultiMedia, IEEE, 3(3):27-36, 1996 (E. Wold, T. Blum, D. Keislar, and J. Wheaten), followed by many others exploring various techniques to summarize the features content such as fingerprinting, HMM and codebook quantization or to multiplex different descriptors together such as Bags of Features (BOF), shingling or block-level features.

Recent references on SUIs such as M. A. Hearst in “Search User Interfaces”, Cambridge University Press, New York, N.Y., USA, 2009, and M. L. Wilson, B. Kules, M. C. Schraefel, B. Shneiderman in “From keyword search to exploration: Designing future search interfaces for the web.” Found Trends Web Sci., 2(1):1-97, January 2010, provide guidelines on how to design and evaluate SUIs, and directions for further research.

### SUMMARY OF THE INVENTION

The present invention discloses a method for indexing audio files comprising the steps of:
i) for each audio file, collecting semantic descriptor of the audio file;
ii) for each audio-file, generate perceptual information based upon audio content of the file;
iii) based upon said perceptual information, generate perceptual descriptor in the form of string data for each audio-file;
iv) for each file, create an index comprising both the semantic data and the perceptual descriptor.

Preferred embodiments of the present invention disclose at least one, or an appropriate combination of the following features:
the semantic descriptor comprises at least one descriptor of the type selected from the group consisting of author, compositor, performer, music genre and instrument;
the perceptual information comprises at least one of pitch salience, dissonance, beat frequency, texture, perceptual sharpness, Mel-frequency cepstrum and spectral flatness;
the generation of the perceptual descriptor comprises the steps of classifying the perceptual information into clusters, each cluster corresponding to a unique string defined in a codebook;
the clusters are defined by a k-means algorithm applied to an initial audio file collection representative of the audio files to be indexed;
the step of generating perceptual information comprises the sub-step of segmenting the audio sound into frames sufficiently small so that the content can be considered static, and generating the perceptual information for each frame, the perceptual information comprising the perceptual descriptor of each frame;
consecutive frames overlap by at least 20% of their temporal length.

A second aspect of the invention is related to Method for retrieving audio content in an indexed database, the index being generated according to any of the previous claims comprising the steps of:
a) recording a query comprising at least one of semantic data or audio content descriptor;
b) search the index in the database for closest audio file according to a reversed index algorithm;
c) output the closest audio files to the user.

Preferably, the audio content descriptor is recorded by inputting an audio content, the index of said audio content being built before the search (query by example).

Advantageously, the output comprises a list of closest semantic data, and a graphical representation of closest perceptual audio files, based upon graphical representation of k-means clusters.

Preferably, the output comprises a list of closest semantic data, and a 2D graphical representation of closest perceptual audio files based upon said perceptual information.

### SHORT DESCRIPTION OF THE DRAWINGS

FIG. 1 represents an example of general workflow of the indexation process.

FIG. 2 represents a screenshot of the SUI of the example built on top of LucidWorks Banana with various widgets for text-based (query, tag cloud, facet) and content-based (similarity map) browsing. The different frames are represented separately in the corresponding FIG. 2a to FIG. 2f.

FIG. 3 represents the evolution of the reliability of the method of the example for different codebook sizes.

FIG. 4 represents the histogram of request durations of the example.

FIG. 5 represents the evolution of the mean request processing time of the example.

### DETAILED DESCRIPTION OF THE INVENTION

The present invention provides a method for retrieving audio files combining content-based features and semantic meta-data search using a reversed index such as Apache Solr deployed in a fully integrated server architecture. The present invention also provides a search user interface with a combined approach that can facilitate the task of browsing sounds from a resulting subset.

The first step in the method of the invention comprises the indexation of the sounds in the database. In the context of the invention, the database should be understood in its broadest sense: it can be a collection of sounds on a local database, or large collections of sounds distributed on distant internet servers.

The indexing process of the perceptual content based indexation comprises two distinct steps:
The creation of a codebook
The indexing using the codebook into a database

The codebook design aims at clustering the feature space into different regions. This is performed by using preferably a hierarchical k-means algorithm on a short but diverse training dataset. The word hierarchical here means that several clustering algorithms are performed one after the other. Moreover those algorithms has advantageously been implemented for GPU architecture. The combination of these both characteristics enables a reduced training time in regards to large collections of several thousands of files.

The first hierarchical layer applies to each audio file individually. Each of them are segmented, feature vectors are computed and a first clusters list is obtained through a k-mean algorithm. The output of this step is a set of N centroids depicting the most frequent features in each file.

The second hierachical layer applies to the whole collection. A second k-mean algorithm is fed with all the centroids of the previous step (i.e. N×F centroids with F the number of files) and outputs the codebook vectors and names.

The indexing involves the same segmentation and feature extraction process as during the codebook creation. Each of those features is then associated to a centroid number (called hash) by browsing the codebook with a K-d tree. The set of hashes represents the file for the selected feature.

The perceptual descriptor can for example be extracted by mediacycle using yaafe or essentia. The kind of analysed perceptual descriptor can for example be selected from the group consisting of:
Statistical descriptors: median, mean, variance, power means, raw and central moments, spread, kurtosis, skewness, flatness;
Time-domain descriptors: duration, loudness, LARM, Leq, Vickers' loudness, zero-crossing-rate, log attack time and other signal envelope descriptors;
Spectral descriptors: Bark/Mel/ERB bands, MFCC, GFCC, LPC, spectral peaks, complexity, rolloff, contrast, HFC, inharmonicity and dissonance;
Tonal descriptors Pitch salience function, predominant melody and pitch, HPCP (chroma) related features, chords, key and scale, tuning frequency;
Rhythm descriptors beat detection, BPM, onset detection, rhythm transform, beat loudness;
Other high-level descriptors: danceability, dynamic complexity, audio segmentation, SVM classifier.

This indexation step preferably also comprises the step of collecting semantic description of the audio file. For example, this collection of semantic data reads the meta-data stored in each file and adds the collected semantic data to the index corresponding to each files. Usually, audio files such as mp3 files comprises at least meta-data concerning the title, the author, the performer and the type of music. Advantageously, the collected meta-data may comprises more semantic descriptor, such as musical instrument . . . For example, a sound file corresponding to the first Gnossienne would include in its semantic descriptor: Satie as composer, classical music, romantic, lento, melancholy, piano and free time.

Metric used in the research process is advantageously based on Jaccard Similarity to allow the definition of a distance between two songs based on both semantic and perceptual features.

### Example

To satisfy speed and scalability constraints over the search among large collections, the design of the system requires as few computation steps as possible during the search events. Practically, it operates in real-time to enable user-friendly navigation and handle collections from a few thousands up to several millions of sounds. To provide such features, a codebook quantization, as described by K. Seyerlehner, G. Widmer, and P. Knees in “Frame level audio similarity-a codebook approach”, Proceedings of the 11th International Conference on Digital Audio Effects (DAFx-08), Espoo, Finland, 2008, aggregating into shingles and an index-based audio search was used. Moreover, in order to easily integrate advanced features of full-text search such as synonyms, stop-words, language support, auto-suggestion, faceting or filtering on the one hand but also to guarantee efficiency, scalability and robustness for Representational State Transfer (REST) applications on the other hand, a reversed index search engine (such as preferably the Solr search engine) has been selected as an intermediate layer to access the database.

The design of the software is based on a REST server architecture and is composed of four entities:
The Sounds Collection contains the audio files on an http server and can be accessed with a simple API including the sound ID.
The Apache SoIr Server enables the database management and search.
The MediaCycle Server directly derives from the Mediacycle software (C. Frisson, S. Dupont, W. Yvart, N. Riche, X. Siebert, and T. Dutoit. Audiometro: directing search for sound designers through content-based cues, In Proceedings of the 9th Audio Mostly Conference: A Conference on Interaction with Sound, Aalborg, Denmark, Oct. 1-3, 2014. ACM). It provides tools for low- and high-level features extraction as well as a content based 2D ranking of results lists.
The User Interface consists in an html5 application offering user-friendly tools for search and navigation.

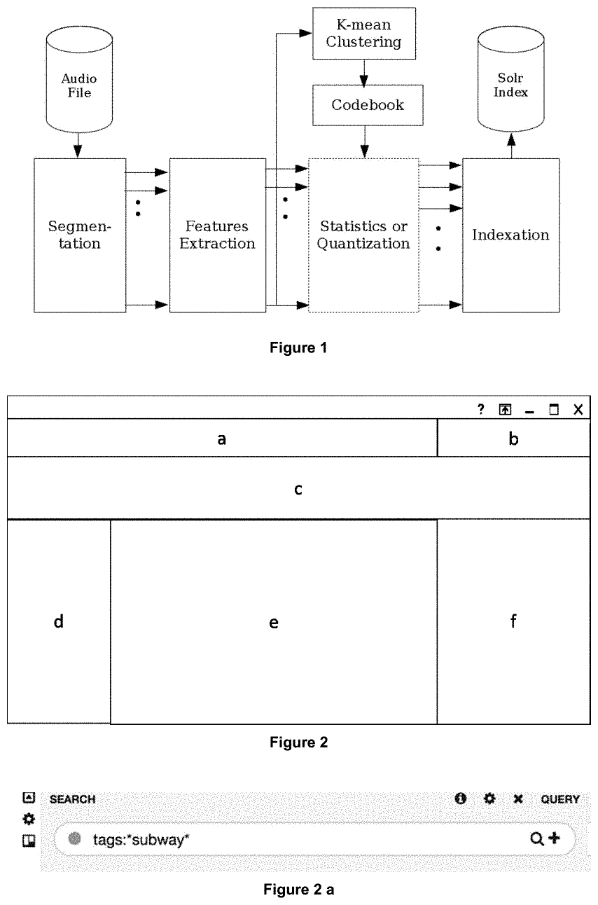

The indexation flows aims at storing a representation of an audio file into the SoIr index. Textual tags can be directly extracted from the audio meta-data or by crawling the web but the audio content needs to go through a more complex process before storage as shown in FIG. 1.

After adjusting the sample rate and size to 22050 Hz and 16 bits respectively, sounds are segmented in 512-sample frames in which the content is supposed to be static. The overlap between two successive frames is 50%. For each frame, multi-dimensional low-level descriptors are computed with Mediacycle. Higher-level features which are closer to the human ear perception such as pitch salience, dissonance, beat frequency (bpm, or beat per minute), texture, perceptual sharpness and spectral flatness are also computed and are integrated to the full system. Finally, statistics such as mean, skewness or kurtosis are computed for some features to become independent of the number of frames. Those are directly stored into the SoIr index.

Long descriptor vectors computed over several frames must be transformed in order to be stored into the SoIr index. To do this, an initial heterogeneous collection large enough to span all the feature range should be available for the realization of a codebook. For each frame of each file in this collection, the audio descriptors are computed. A multi-core k-mean clustering initially seeded with the k++ algorithm is then performed in each descriptor space to compute N cluster positions per file. As the sounds used in the collection used in this example rarely last more than 20 seconds, i.e. approximately 2000 frames, N was selected equal to 20as it was assume that a sound is quite similar over its whole duration so the granularity should not be too high. Then, from all the clusters computed for each file, a second k-mean clustering algorithm was performed on a GPU hardware using the CUDA libraries to speed up the process. This results in M clusters for each descriptors stored in a codebook, where M must be chosen to guarantee the best granularity of the quantization depending on the collection size.

Once the codebook has been computed with an initial collection, it can be reused for each new file indexation as long as the collection remains homogeneous enough. For each new sound to be indexed, a k-d tree algorithm finds the nearest cluster for each frame and each descriptor and concatenates the cluster indices into a hash string whose length varies with the sound duration.

When sent into the Solr indexation pipe, the different files fields are subjected to analyzers and tokenizers. In the current configuration, two strategies are taken into account. Either the hash is split between its clusters and the duplicates are removed which results in a set of single cluster terms; or it is split into shingles, i.e. a concatenation of a fixed number of consecutive clusters. Statistics are for their part directly stored as float scalar or vectors.

The search flow involves different filters, analyzers and similarities for each field that can be queried. Each field query returns a list of results ranked according to the score produced by the similarity. Several fields can also be combined to create multi-field queries.

When a text-based search is performed through the SoIr API, the default TF-IDF similarity is applied. The score computation can be summarized like this:

$$Score ( q , d ) = {\sum }_{t ∈ q} ( tf ( t , d ) . {idf ( t )}^{2} . norm ( t , d ) ) . coord ( q , d ) . queryNorm ( q )$$

Where t means term, q is the query and d the document. tf (t, d) is a measure of how often a term t appears in a document; idf (t) is a factor that diminishes the weight of the more frequent terms in the index; norm(t, d) and queryNorm(q) are two normalization factors over the query and the documents and coord(q, d) is a normalization factor over the query-document intersection.

The metric used to compute a distance between two sounds according to one audio feature is the Jaccard Similarity:

$$J ( {S}_{1} , {S}_{2} ) = \frac{{S}_{1} ⋂ {S}_{2}}{{S}_{1} ⋃ {S}_{2}}$$

Where S1 and S2 are the feature hashes sets of the two files that are compared. It should thus be noted that this index is neither sensitive to the hash position (a common frame has the same weight in the distance computation wherever the moment it happens in the sound) nor to the size of the sound (a long sound will be close to a short one if it possesses the same hashes or the same shingles all through its duration). By resetting the different functions tf (t,d), idf (t) norm(t,d), coord(q,d), queryNorm(q) it is possible to approximate the Jaccard Similarity with a very small error in SoIr.

As audio statistics are directly entered as float number in the SoIr index, it is not possible to compute a ranking score over this field. However, they can be used to filter the results using faceting, i.e. by removing the results whose statistics are not in a given range.

The web-based UI of the example was prototyped with LucidWorks Banana, a flexible information visualization dashboard manager similar to Google Analytics. It allows to layout several panels on a dashboard page, for instance to interactively display: the current text query, the amount of hit results, facets to filter the results, a tag cloud of the words present in the results. A panel to display a map of results was developed based on the AudioMetro layout for presenting sound search results organized by content-based similarity, implemented with the Data-Driven Documents (d3js) library (M. Bostock, V. Ogievetsky, and J. Heer, D3 data-driven documents. IEEE Transactions on Visualization and Computer Graphics,

### 17(12):2301-2309, December 2011).

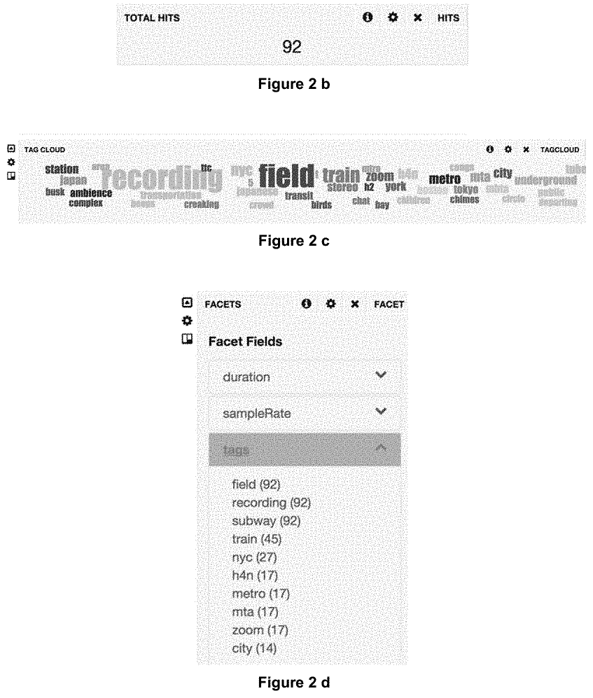

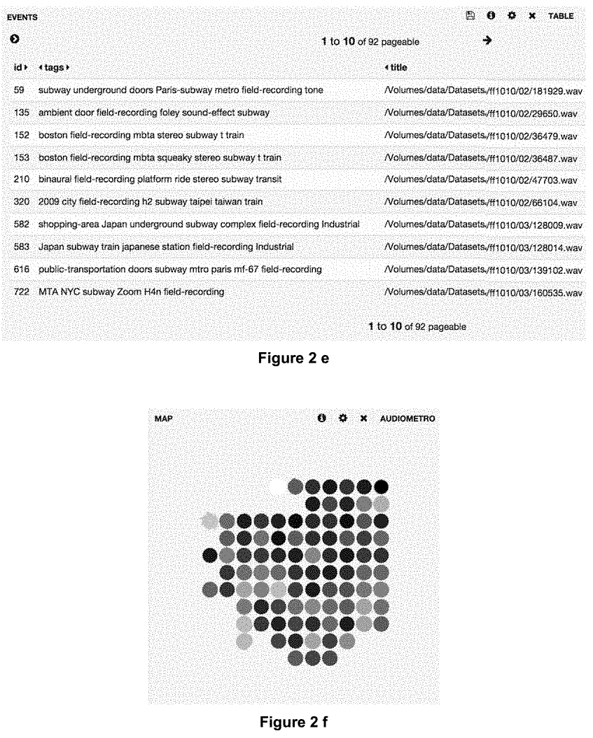

Sounds are represented by glyphs (currently mapping the mean and temporal evolution of audio perceptual sharpness respectively to visual brightness and contour) and positioned in a map obtained by dimension reduction applied to several audio features into 2D coordinates snapped into a proximity grid. A dashboard sporting the aforementioned widgets is illustrated in FIG. 2.

In order to evaluate and optimize the performances of the system, an annotated database called Urban Sound8K5 composed of approximately 8000 sounds classified in 10 categories according to their content was used. For each sound in the database, several MFCC-based hash were computed with different codebooks containing 32 to 65536 clusters. Then, requests over their hash fields were performed through the SoIr API and the first 5 to 40 results were analyzed. SoIr is running on a basic 8-core laptop with 16 GB of RAM memory. We ranked the results against two criteria:
Reliability: defined as the true positive rate among the first results, i.e. the rate of sound falling in the same category as the request;
Speed: to ensure the robustness in the context web applications we measured the processing search time (network access time is not taken into consideration).

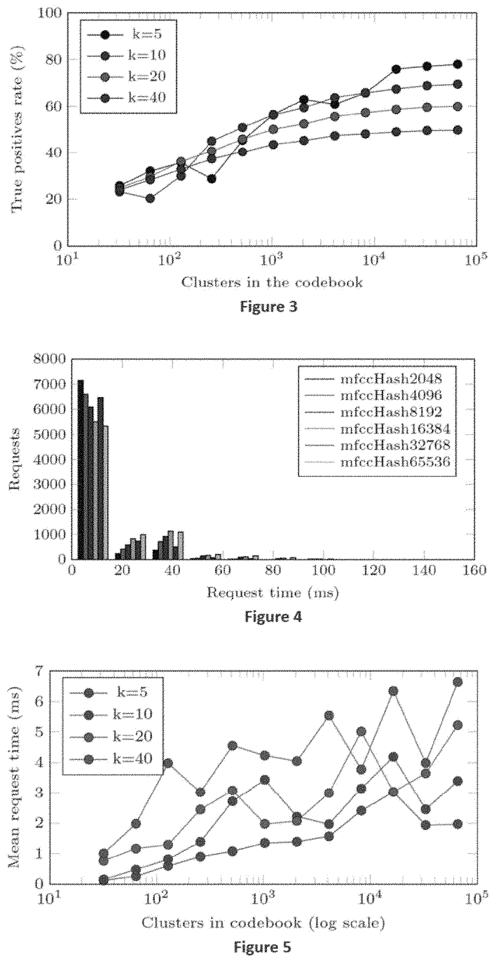

On FIG. 3, the reliability is represented for different codebook sizes on a logarithmic scale. Two details can be highlighted: first, the reliability rate increase is much slower for high number of clusters. This means that increasing the codebook size will not really affect the results from a certain value depending on the collection size. Then, the reliability among the very first results is better than among the next one, which tends to confirm that the scoring function has been correctly designed.

FIG. 4 represents an histogram of the request time. As Solr relies on many tools such as cached memory or preloaded index to optimize the search process, it is difficult to predict the exact response time for each request but the histogram enables to verify that this processing time range always remains correct for real time application.

FIG. 5 displays the evolution of the mean search time for different codebook sizes on a logarithmic scale. It indicates that the mean processing time increases proportionally to the logarithm of the index size which represent the best complexity that can be obtained for a index based search. Even if those figures remain relatively low (a few milliseconds for a request), it can influence the choice of the codebook size. Besides, it must be noted that the k-mean clustering and the indexation times also increase with this size and it can become computationally too expensive for several thousands of clusters.

Finally, other parameters like scalability or memory usage are mainly dependent on the Solr software performances.

The disclosed example described a tool combining audio and semantic features to index, search and browse large Foley sound collections. A codebook approach has been validated in terms of speed and reliability for a specific annotated collection of sounds.

1. Method for indexing audio files comprising the steps of:
i) for each audio file, collecting semantic descriptor of the audio file;
ii) for each audio-file, generate perceptual information based upon audio content of the file;
iii) based upon said perceptual information, generate perceptual descriptor in the form of string data for each audio-file;
iv) for each file, create an index comprising both the semantic data and the perceptual descriptor.

2. Method according to claim 1 wherein the semantic descriptor comprises at least one descriptor of the type selected from the group consisting of author, compositor, performer, music genre and instrument.

3. Method according to claim 1 wherein said perceptual information comprises at least one of pitch salience, dissonance, beat frequency, texture, perceptual sharpness, Mel-frequency cepstrum and spectral flatness.

4. Method according to claim 1 wherein the generation of the perceptual descriptor comprises the steps of classifying the perceptual information into clusters, each cluster corresponding to a unique string defined in a codebook.

5. Method according to claim 4 wherein the clusters are defined by a k-means algorithm applied to an initial audio file collection representative of the audio files to be indexed.

6. Method according to claim 1 wherein the step of generating perceptual information comprises the sub-step of segmenting the audio sound into frames sufficiently small so that the content can be considered static, and generating the perceptual information for each frame, the perceptual information comprising the perceptual descriptor of each frame.

7. Method according to claim 6 wherein consecutive frames overlap by at least 20% of their temporal length.

8. Method for retrieving audio content in an indexed database, the index being generated according to any of the previous claims comprising the steps of:
a. recording a query comprising at least one of semantic data or audio content descriptor;
b. search the index in the database for closest audio file according to a reversed index algorithm;
c. output the closest audio files to the user.

9. Method according to claim 8 wherein the audio content descriptor is recorded by inputting an audio content, the index of said audio content being built before the search (query by example).

10. Method according to claim 8 wherein the output comprises a list of closest semantic data, and a graphical representation of closest perceptual audio files, based upon graphical representation of k-means clusters.

11. Method according to claim 8 wherein the output comprises a list of closest semantic data, and a 2D graphical representation of closest perceptual audio files based upon said perceptual information.
